(19) United States
(12) Patent Application Publication
(10) Pub. No.: US 2011/0101708 A1
(43) Pub. Date: May 5, 2011

(54) PIVOT LEVER ACTUATION HAVING SAFETY DEVICE

(76) Inventors: Sebastian Koch, Wuppertal (DE); Andreas Langenberg, Schwelm (DE); Markus Schulte, Ennepetal (DE)

(21) Appl. No.: 12/922,617

(22) PCT Filed: Mar. 12, 2009
(86) PCT No.: PCT/EP09/01779

§ 371 Date: Nov. 15, 2010

(30) Foreign Application Priority Data
Mar. 15, 2008 (DE) 20 2008 003 720.4
Apr. 15, 2008 (DE) 20 2008 005 166.5

(51) Int. Cl. E05C 3/08

(52) U.S. Cl. 292/200

(57) ABSTRACT

A swivel lever actuating mechanism including a trough. The trough has a shoulder which pierces the fastening plane formed by the thin wall in the direction toward the other side of the thin wall. The trough also supports a drive shaft at which a hand lever with a projection is arranged which is swivelable out of the trough. First locking devices proceed from the trough or hand-lever-projection and cooperate with second locking devices. Independently acting locking devices are provided for the free end of the hand lever. A mechanical drive provided with a cam is arranged in the hand-lever-projection so that the cam moves the locking devices into the open or closed position when the mechanical drive is actuated. A pin with an electric drive is arranged in the trough so that the locking devices are moved into the closed or open position when the electric drive is actuated.

The present application claims priority from PCT Patent Application No. PCT/EP2009/01779 filed on Mar. 12, 2009, which claims priority from German Patent Application No. DE 20 2008 003 720.4 filed on Mar. 15, 2008, and German Patent Application No. DE 20 2008 005 166.5 filed on Apr. 15, 2008, the disclosure of which is incorporated herein by reference in its entirety.

### BACKGROUND OF THE INVENTION

1. Field of the Invention

The invention is directed to a swivel lever actuating mechanism with a safety device, comprising a trough which can be arranged on one side (outer side) of a thin wall such as a switch cabinet door, which trough has, at one of its longitudinal ends, a shoulder whose cross section is substantially rectangular and which pierces the fastening plane formed by the thin wall in the direction toward the other side (inner side) of the thin wall, its other longitudinal end supporting a drive shaft at which a hand lever is arranged so as to be swivelable out of the trough around an axis parallel to the fastening plane and optionally rotatable in the trough around an axis perpendicular to the fastening plane, and locking devices proceed from the trough or hand lever projection which cooperate with complementary locking devices of the hand lever projection or trough.

2. Description of Related Art

A swivel lever actuating mechanism with a safety device is already known from DE 60206687 D2. Further, DE 202007006513 U1 is also cited in this connection.

In both cases, there is a locking pin which can be made to move out electrically and a cylinder lock which can be actuated mechanically and which is suitable to release the hand lever from the locked position in case of a power outage.

Both of these known constructions have the disadvantage that the stability of the tumbler is not optimal.

### SUMMARY OF THE INVENTION

It is the object of the invention to provide a swivel lever actuating mechanism having a safety device in which the disadvantage of the known arrangement is overcome.

The above-stated object is met in that one or two independently acting mechanical locking devices are provided for the free end of the hand lever, in that a mechanical drive such as a locking cylinder provided with a cam is arranged in the hand lever projection in such a way that the cam moves the locking devices into the open or closed position when the locking cylinder is actuated, and in that at least one pin with an electric drive is arranged in or at the trough in such a way that the locking devices are moved into the closed or open position when the electric drive is actuated. This construction makes possible an embodiment form which is substantially more stable than those in the prior art. Further, a conceivable construction which is also realized in an embodiment form prevents the rattling effect that is possible in standard locks and, therefore, excludes any play by means of spring devices. In particular, according to a further development of the invention, the locking device comprises a slide which is displaceable against spring force or gravitational force in a push bearing formed by the shoulder.

Alternatively, the locking device can comprise a lever in place of the slide device, which lever is swivelable against spring force or gravitational force in a lever bearing formed by the shoulder.

The slide or the lever can have an end formed as a latch, which facilitates the closing process.

The latch-like end can have a piston-like end opposite the slide, which facilitates cooperation with an electrically actuatable pin and improves guiding.

The slide or the lever can have a projection or recess arranged between the latch-like end and the piston-like end, the mechanical drive engaging with the projection or recess in the manner of a cylinder cam in order to move it against the spring force or gravitational force.

The slide or the lever can have a bore hole which is open at both ends or a cylinder for receiving the piston and the pin.

In another embodiment form, the slide or the lever forms a holding surface next to the inclined run-in surface forming the latch, this holding surface forming an angle relative to the latter. This is advantageous particularly for locking without play.

In particular, the holding surface of the slide or of the lever can form an angle to its movement direction such that the holding forces are overcome (spring lock function) when the actuating lever is swung out.

The slide or the lever can encounter an opposite surface to the holding surface so as to contain any movement play by the action of spring force or gravitational force.

The slide or the lever can be arranged next to one mechanical drive or between two mechanical drives such as two cylinders provided with cams.

Alternatively, the electric drive can be arranged below the mechanical drive and, additionally, a second electric drive can be arranged between the mechanical drive and the bearing of the hand lever.

The mechanical drive can be formed by two cylinder locks with shared slides, which is advantageous in certain cases of application with two access authorizations.

Greater mechanical stability is achieved when the electric drive and the mechanical drive, and electronic components, if any, are arranged jointly on the same base plate.

### BRIEF DESCRIPTION OF THE DRAWINGS

FIG. 1 shows a perspective view showing the external parts of a swivel lever actuating mechanism with safety device constructed according to the invention, wherein two locking cylinders are provided;

FIG. 2 shows a rear view of the swivel lever actuating mechanism according to FIG. 1 installed in a door leaf;

FIG. 3A shows the arrangement according to FIG. 2 in section parallel to the door leaf plane, wherein the lift magnet is not excited;

FIG. 3B shows the same view as in FIG. 3A, but with excited lift magnet;

FIG. 4A shows a perspective view of the arrangement according to FIG. 3A;

FIG. 4B shows a perspective view of the arrangement according to FIG. 3B;

FIG. 5A shows an embodiment form with only one locking cylinder viewed from the back; the cylinder is in the neutral position and the lift magnet is excited;

FIG. 5B shows the arrangement according to FIG. 5A, but with the lift magnet not in the excited state;

FIG. 5C shows the arrangement according to FIG. 5A in which the lift magnet is not excited but the locking cylinder is actuated;

FIG. 6A shows a detailed view of the locking arrangement, the lift magnet pin and locking cylinder under the same conditions shown in FIG. 5A;

FIG. 6B shows a corresponding view under the conditions shown in FIG. 5B;

FIG. 6C shows the conditions according to FIG. 5C;

FIG. 7A shows a perspective view showing the external parts of an embodiment form similar to FIG. 1;

FIG. 7B shows a rear view of the actuating mechanism installed in a door leaf similar to FIG. 1B, but with a different arrangement of the individual components and with a lateral holding plate;

FIG. 7C shows the arrangement according to FIG. 7A in section parallel to the door leaf plane, wherein the lift magnet is not excited;

FIG. 7D shows the same view as in FIG. 7B, but with excited lift magnet;

FIG. 7E shows the same view as in FIG. 7B, but with actuation by means of the cam of a cylinder lock;

FIG. 8A shows a perspective view showing the external parts of an embodiment form similar to FIG. 8A, but with only one cylinder lock;

FIG. 8B shows a rear view of the actuating mechanism installed in a door leaf similar to FIG. 7B, but with a different arrangement of the holding plate, namely parallel to the door leaf plane;

FIG. 8C shows the arrangement according to FIG. 8A in section parallel to the door leaf plane, wherein the lift magnet is not excited;

FIG. 8D shows the same view as in FIG. 8B, but with excited lift magnets; and

FIG. 8E shows the same view as in FIG. 8B, but with actuation by means of the cam of a cylinder lock.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

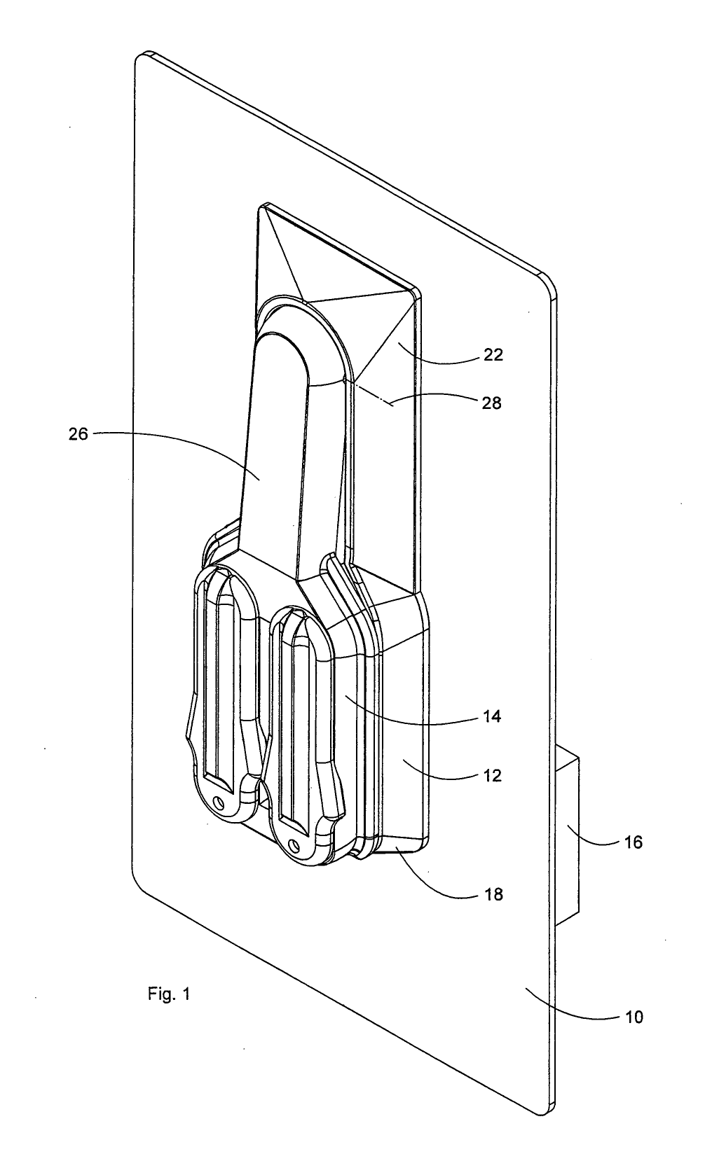

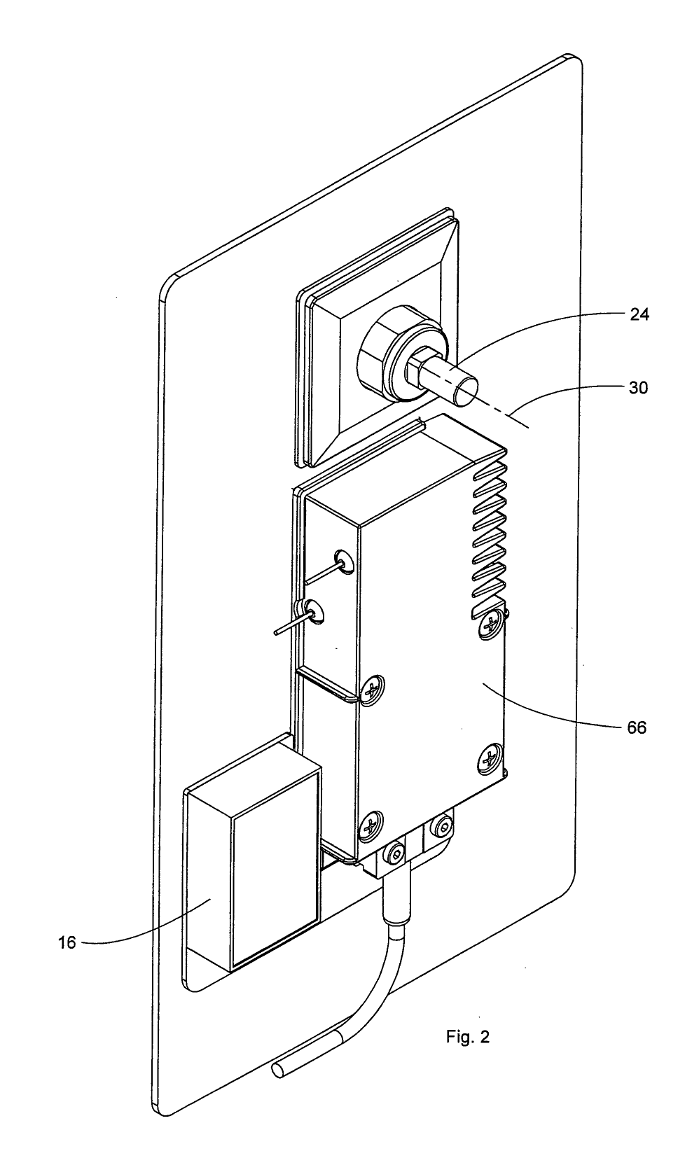

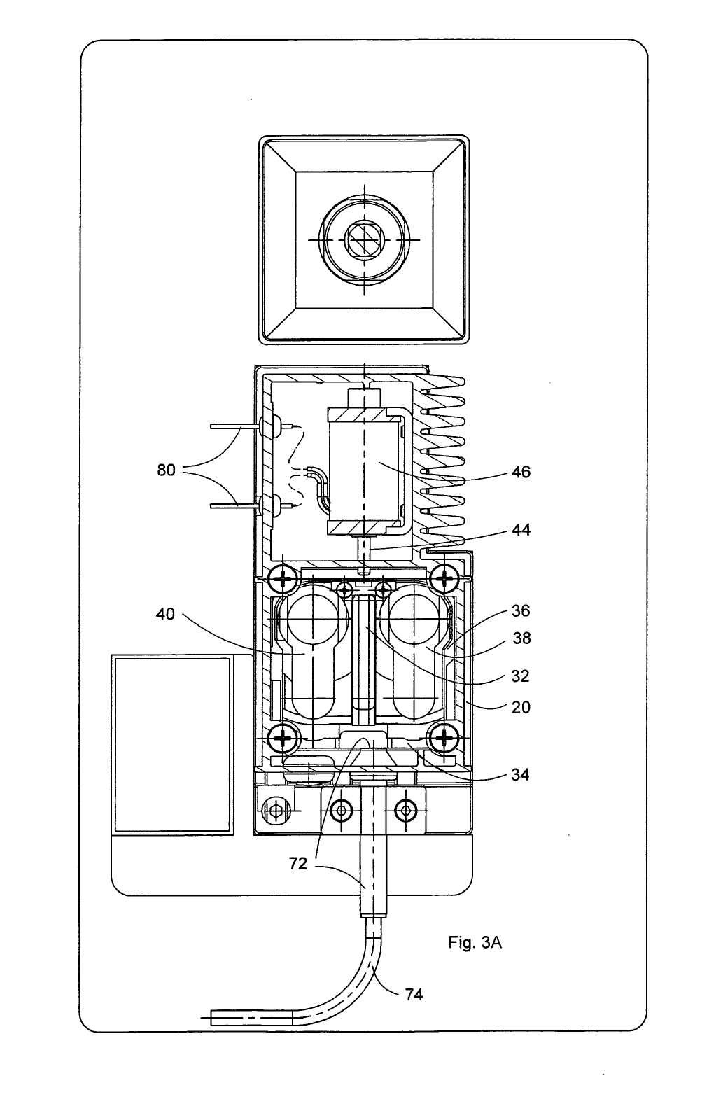

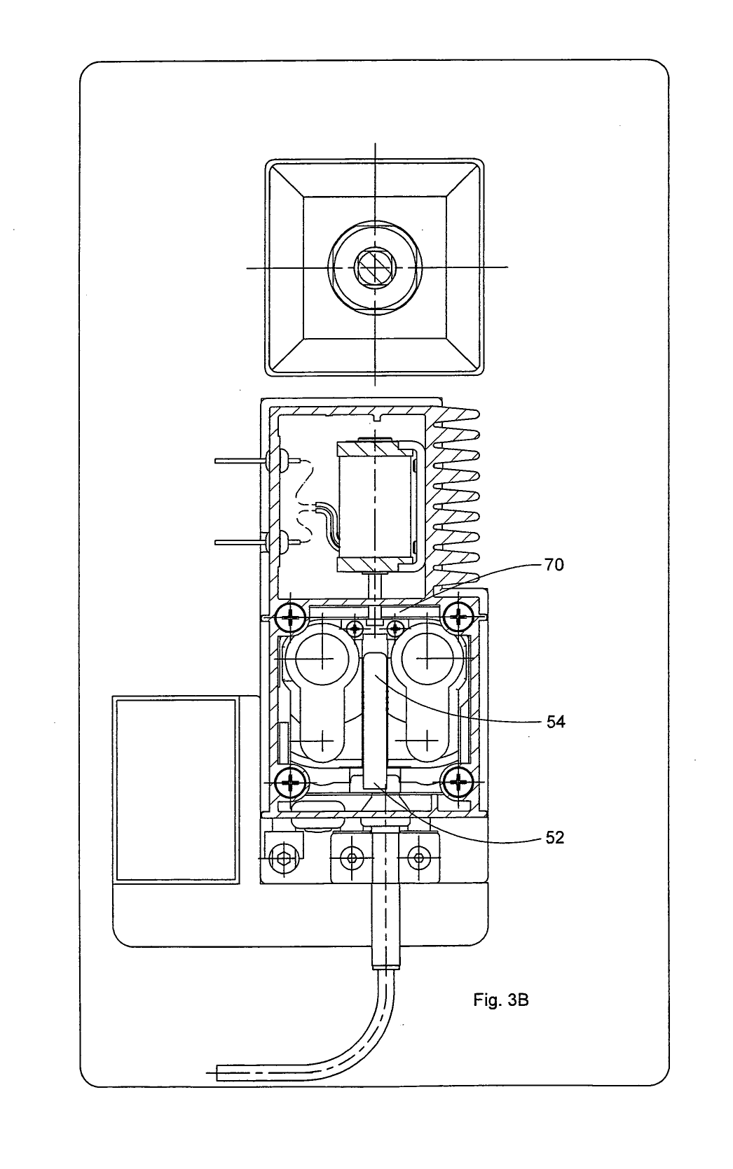

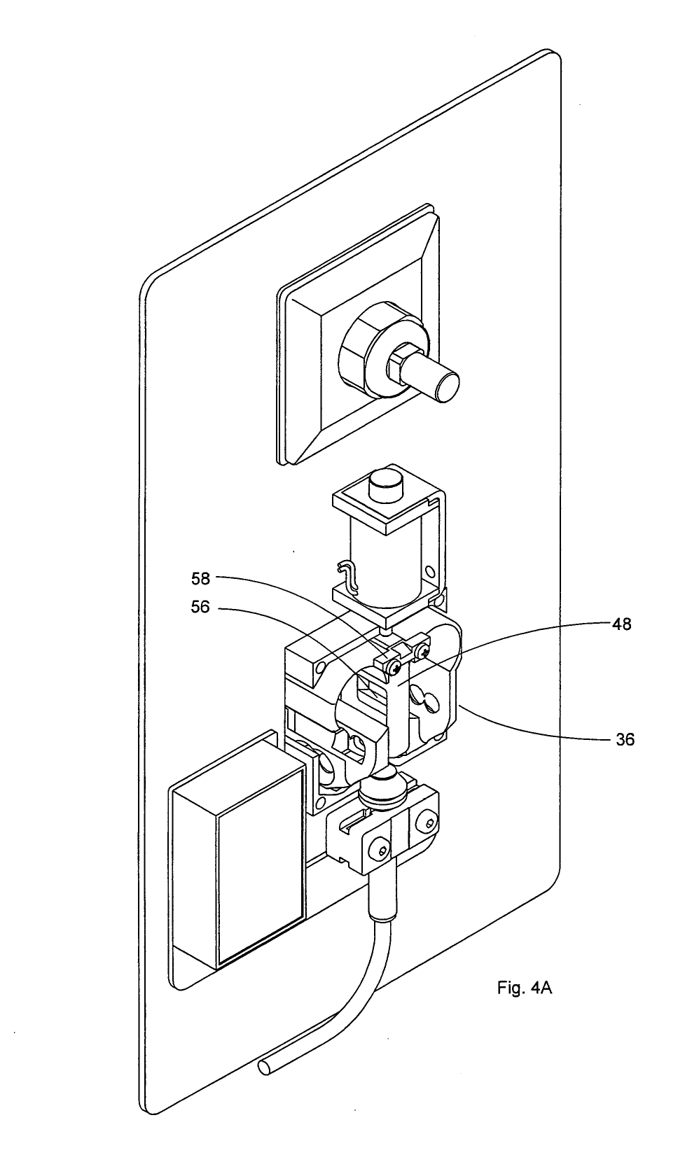

FIG. 1 is a perspective view showing a trough 12 of a swivel lever actuating mechanism 14 with a safety device 16. The trough 12 can be arranged on one side (outer side) of a thin wall 10 such as a switch cabinet door and has, at one of its longitudinal ends, a shoulder 20 whose cross section is substantially rectangular and which pierces the fastening plane formed by the thin wall 10 in the direction toward the other side (inner side) (see FIGS. 2 and 3), and its other longitudinal end 22 supports a drive shaft 24 at which a hand lever 26 is arranged so as to be swivelable out of the trough 12 around an axis 28 parallel to the fastening plane and, in the present embodiment form, so as to be rotatable in the trough 12 around an axis 30 (see FIG. 2) perpendicular to the fastening plane. A projection 36 also projects from the hand lever 26. Locking devices 32 proceed from the trough 12 or hand lever projection 36 and cooperate with complementary locking devices 34 of the hand lever projection 36 or trough 12.

A mechanical drive such as a locking cylinder 38, 40 provided with a cam is arranged in the hand lever projection 36 in such a way that the cam 42 moves the locking devices into the open or closed position when the locking cylinder is actuated, and a pin 44 with an electric drive 46 is arranged in the trough 12 in such a way that the locking devices 32, 34 are moved into the closed or open position when the electric drive 46 is actuated.

The closed position is shown in FIG. 3b, and the open position is shown in FIG. 3A.

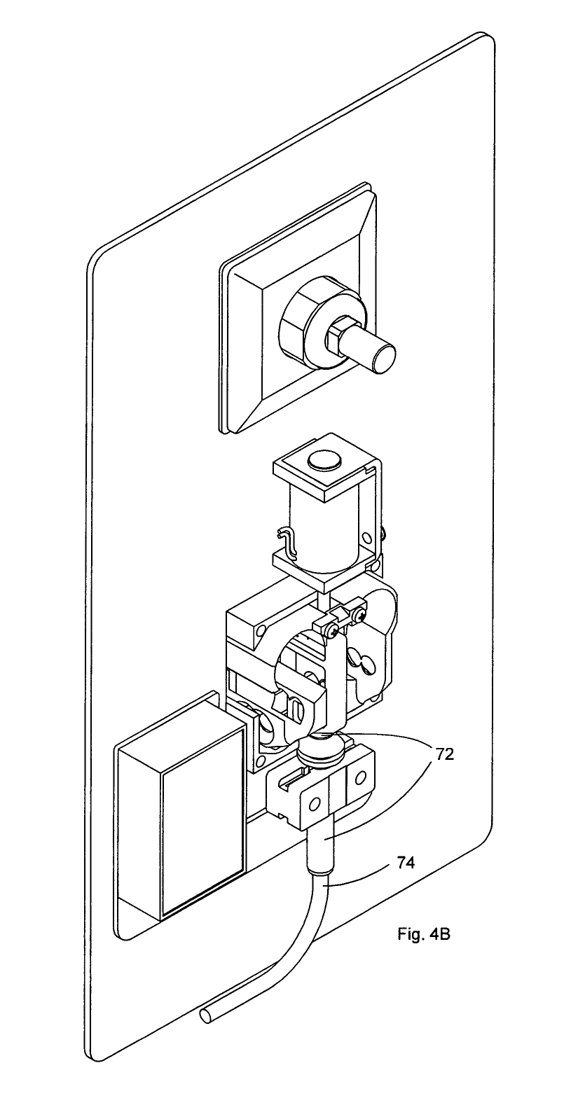

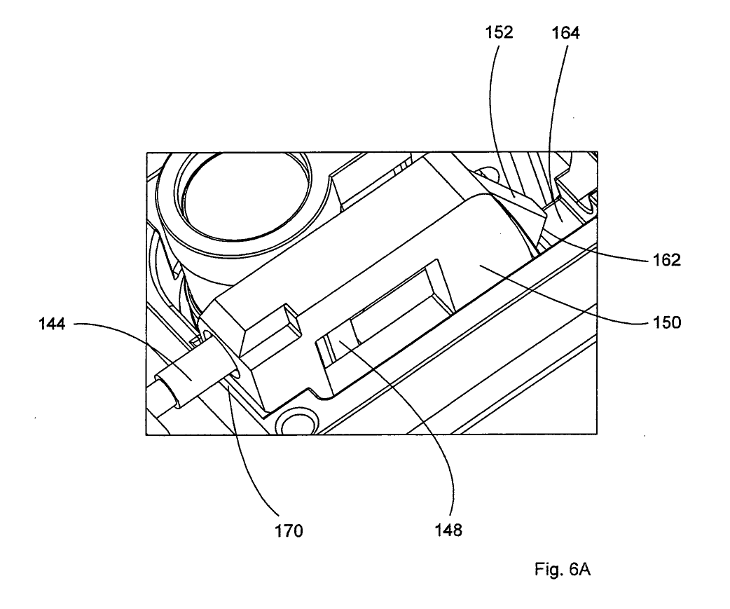

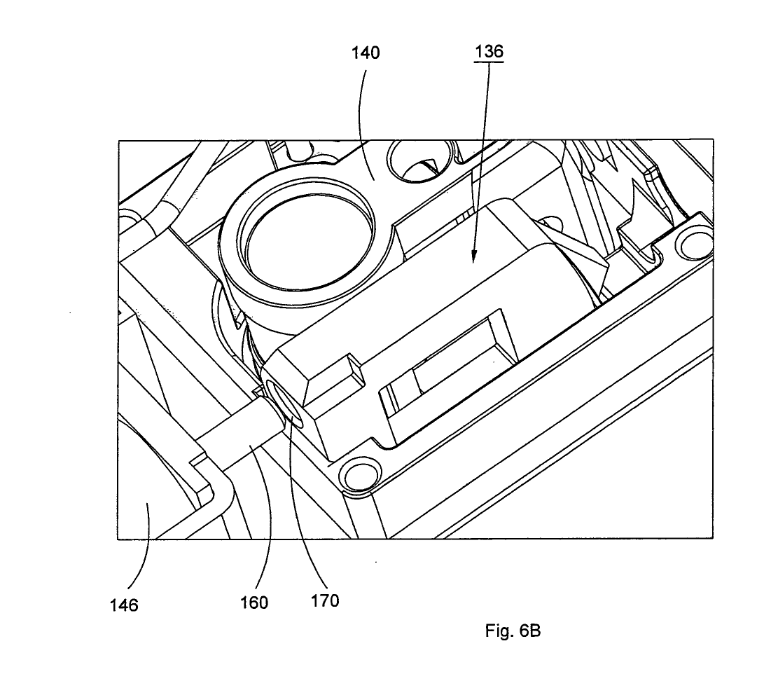

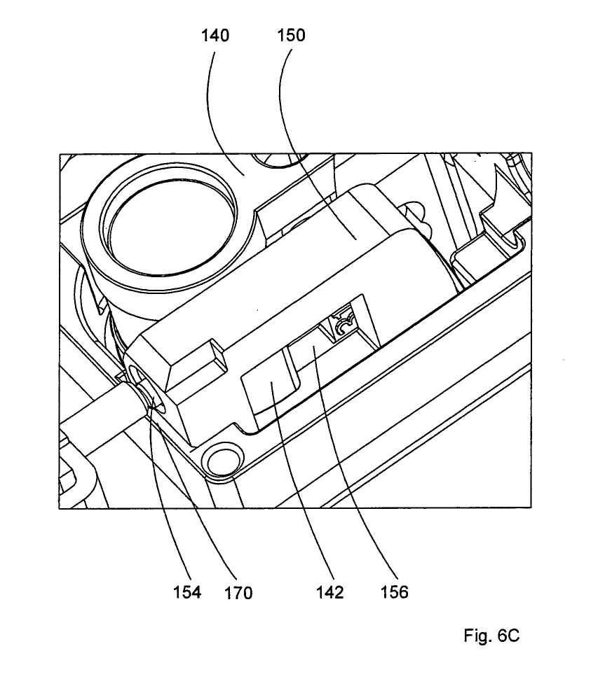

The locking device 32 comprises a slide 48 (see FIG. 4A) which is displaceable against spring force or gravitational force in a push bearing 50 or 150 (FIG. 6A) formed by the projection 36 of the hand lever 26. Instead of the slide, a lever can also be provided which may be swivelable against spring force or gravitational force in a swiveling bearing formed by the projection.

The latter embodiment form is not shown.

The slide 40 (or the lever) can have an end which is formed as a latch, i.e., can be a closing actuating device or lever actuating device which enters automatically by means of a run-in rail or run-in surface.

FIG. 6A shows this inclined run-in surface 152 in connection with an embodiment form having only one locking cylinder.

As is shown in FIG. 6C, the slide (or the lever) 48, 148 can have a piston-like end 54, 154 opposite the latch-like end 52, 152.

The slide 48, 148 or the lever can have a projection 58, 158 or recess 156 arranged between the latch-like end 52, 152 and the piston-like end 154, 154, the mechanical drive, such as a cylinder cam 42, 142, engaging with the projection 58, 158 or recess 156 to move it against spring force or gravitational force.

The push bearing 50 can have a bore hole 160 or cylinder for receiving the piston 154 or the pin 144.

The slide 48, 148 (or the lever) can form a holding surface 62, 162 next to the inclined run-in surface 52, 152 forming the latch, which holding surface 62, 162 forms an angle relative to the latter.

The holding surface 162 of the slide 148 can form an angle to its movement direction such that the holding forces are overcome (spring lock function) when the actuating lever is swung out.

The slide 150 can also encounter an opposite surface 164 so as to contain any movement play by the action of spring force or gravitational force.

While a locking cylinder 140 with a cam 142 represents the mechanical drive in the embodiment form according to FIGS. 6A to 6C, the slide 48 is arranged between two mechanical drives in the form of two cylinders 38, 40 provided with cams in the embodiment form according to FIGS. 3A to 3C.

The construction shown in FIGS. 3A to 3C can also be closed by means of a cover 66 as can be seen in FIG. 2.

To increase stability, the trough can form a supporting surface 70, 170 for the pin which lies near the push bearing.

The state of actuation at any time is determined by means of a sensor 72, 172, 372 which sends a signal to a monitoring station via a cable 74, 174, 374 during the convergence of the push plate and locking devices 32. The safety device 16 is supplied with power and control signals, and signals are also possibly sent to a monitoring device, via another cable 76.

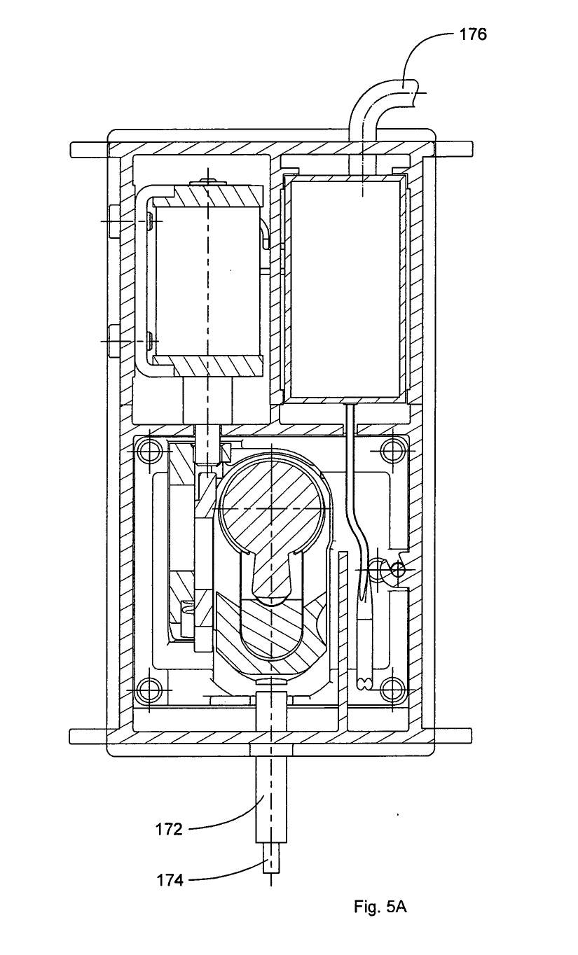

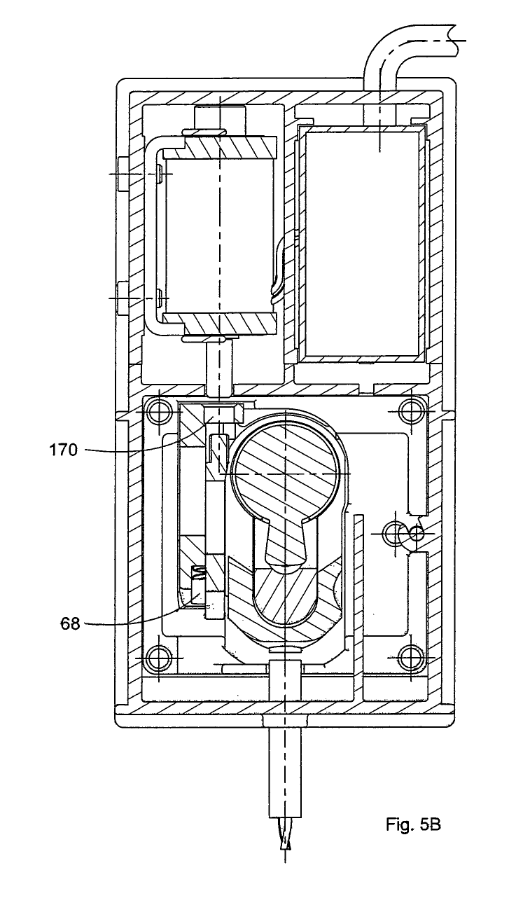

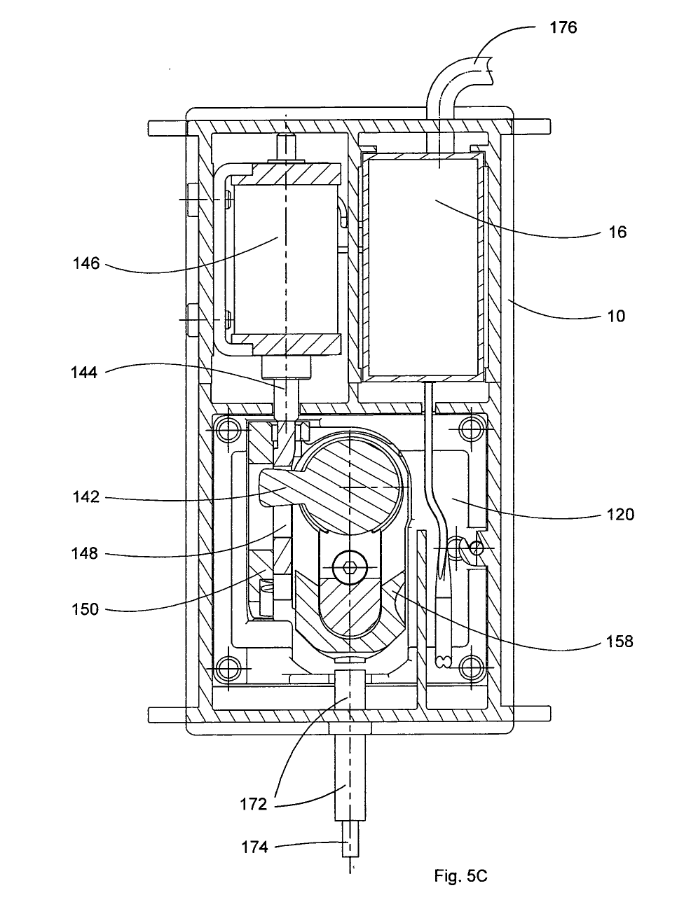

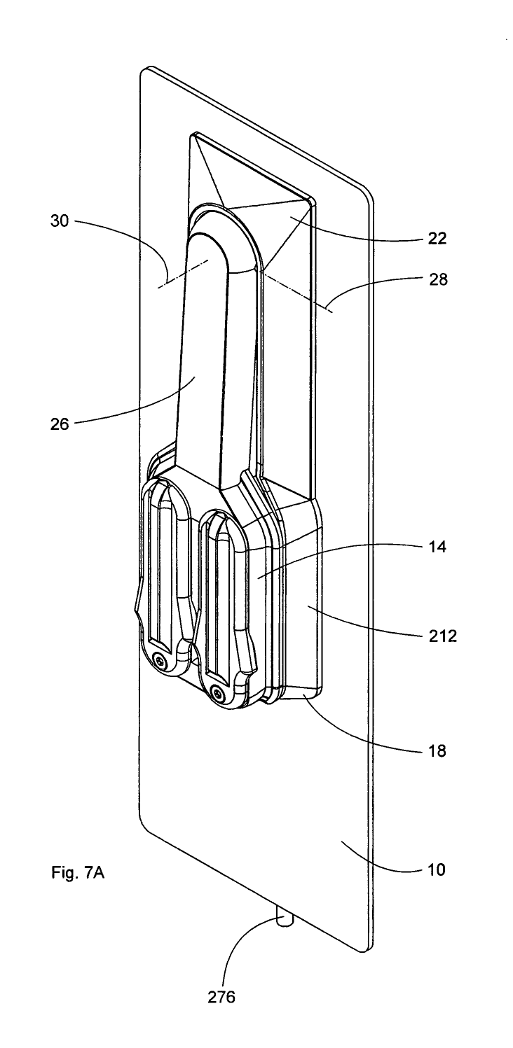

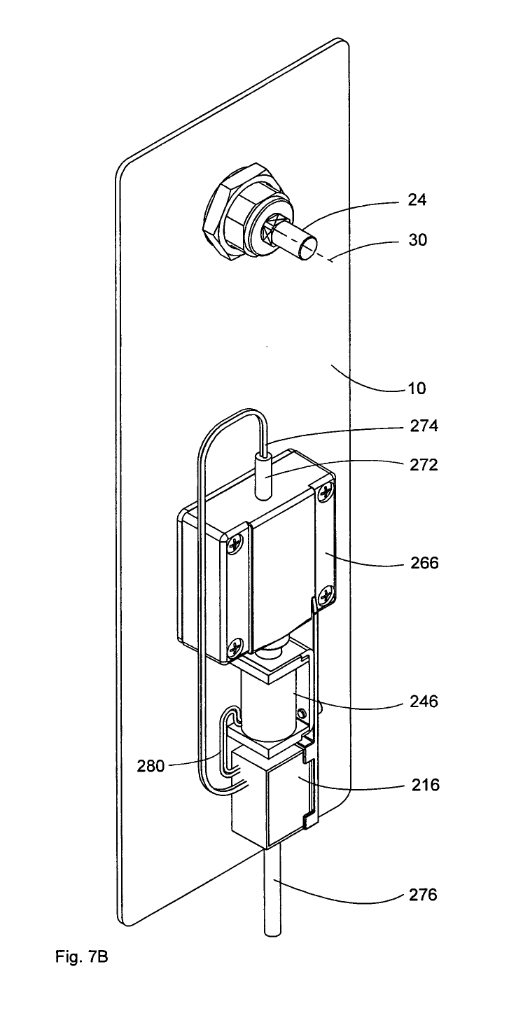

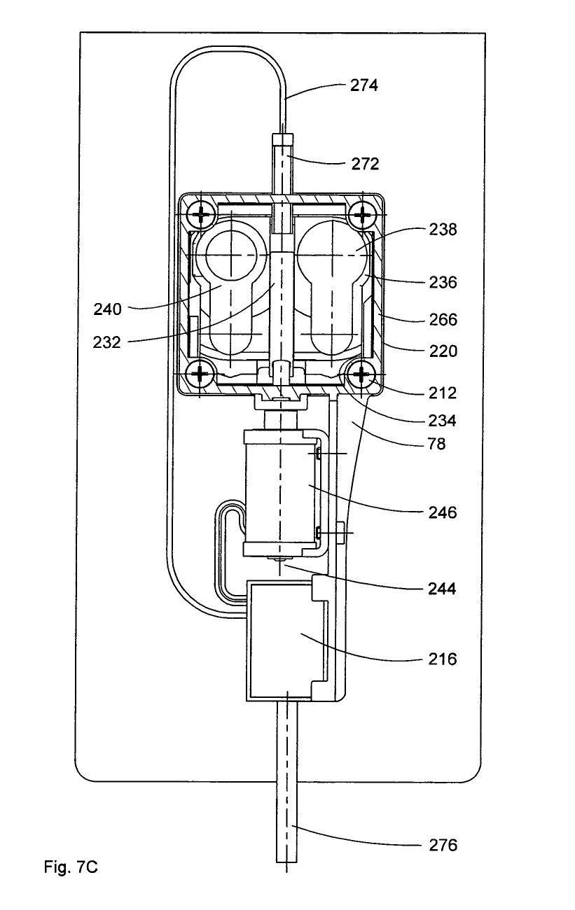

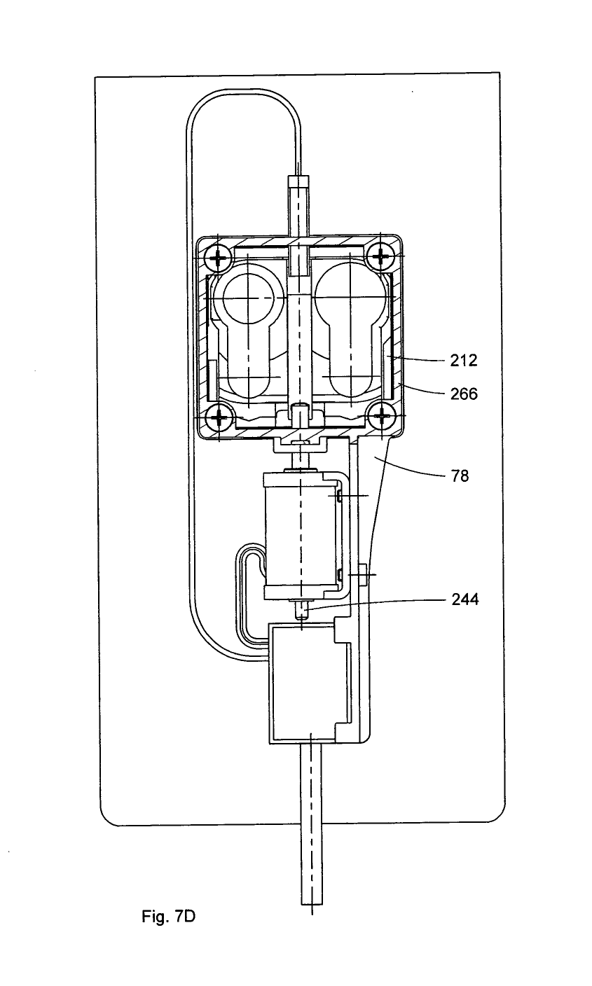

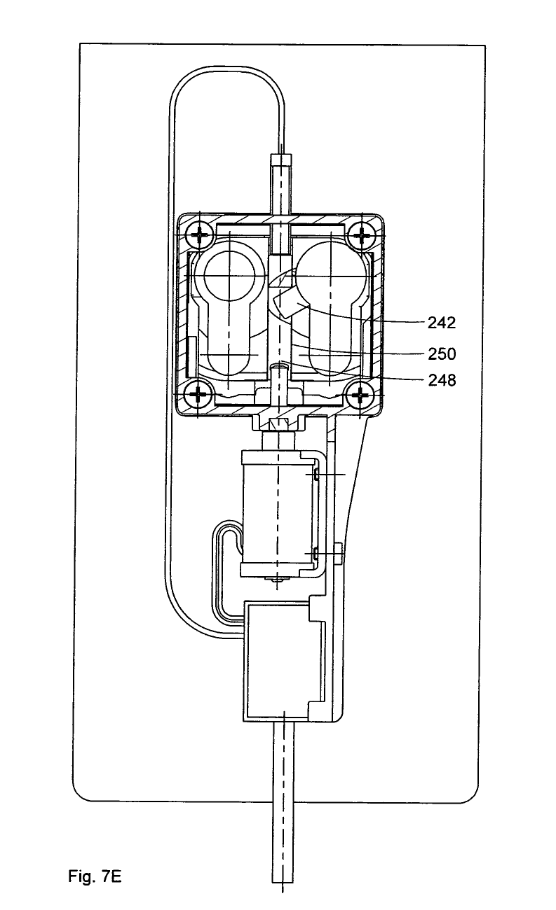

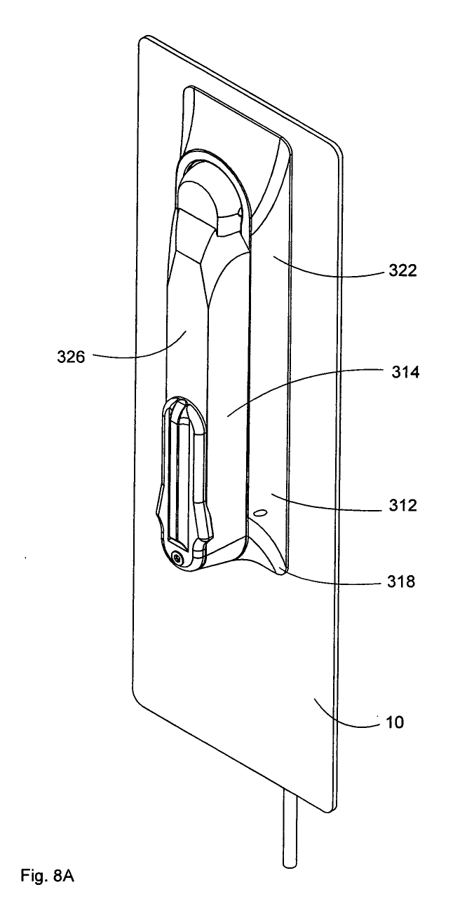

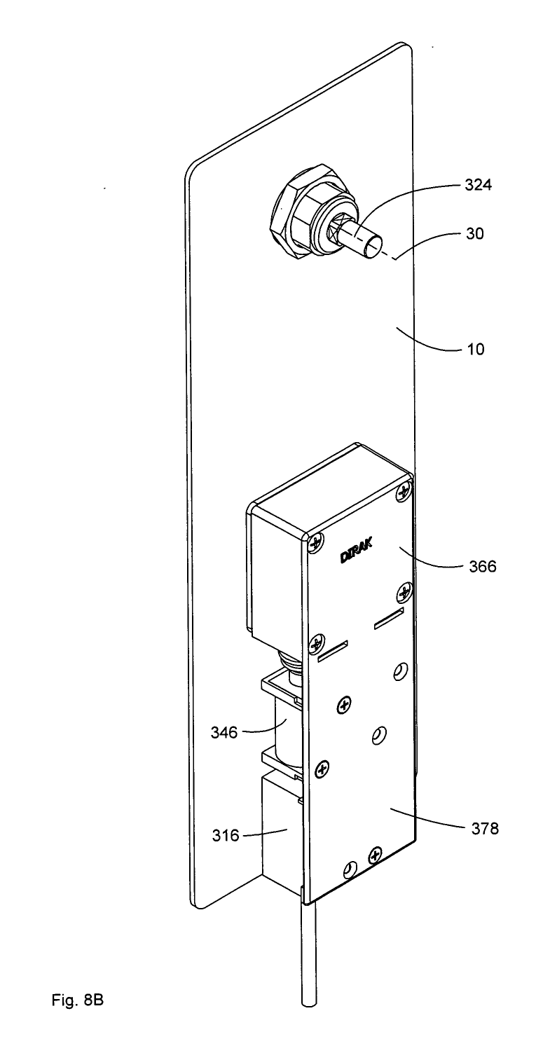

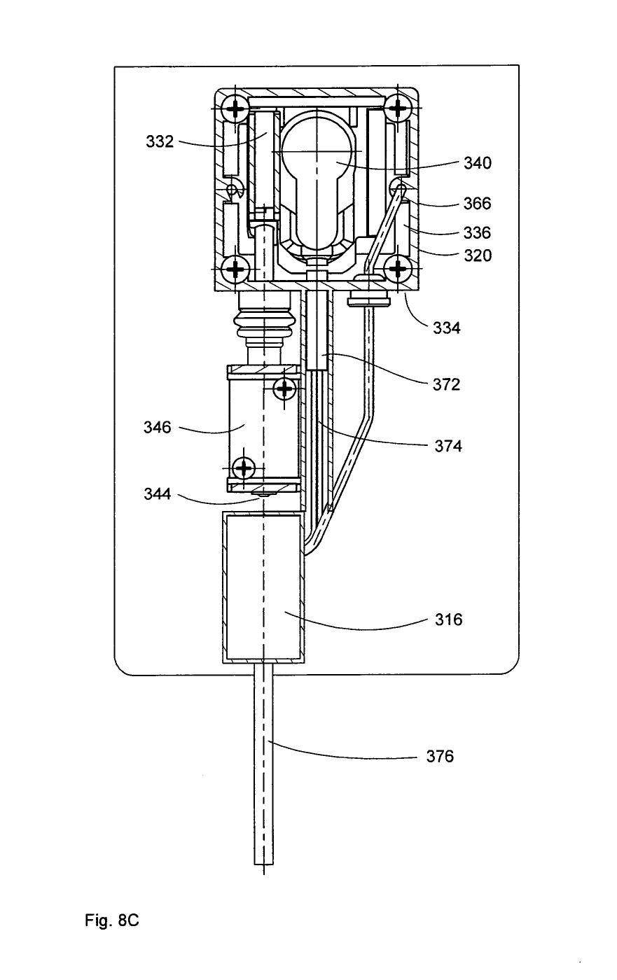

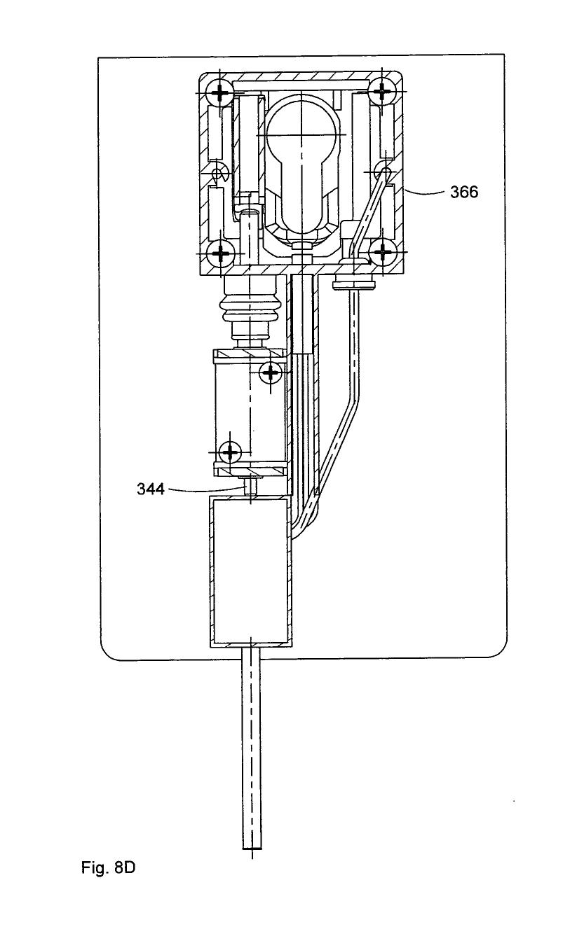

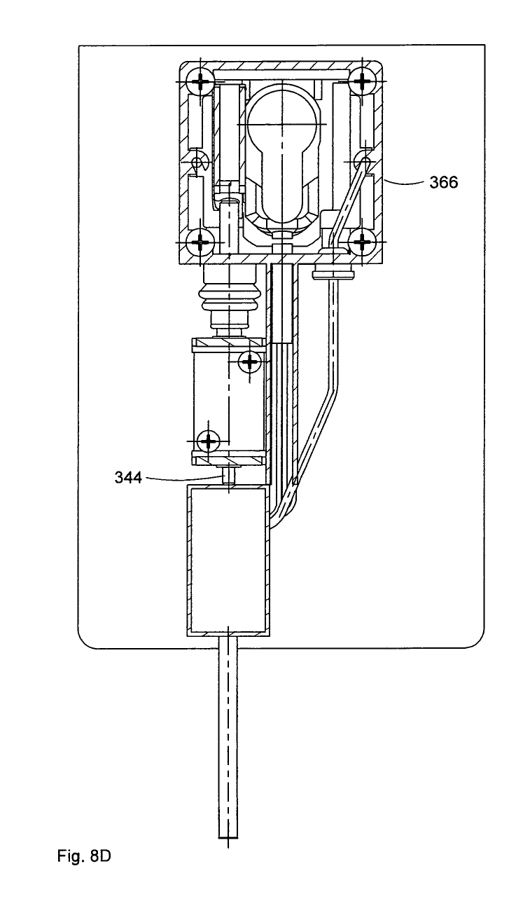

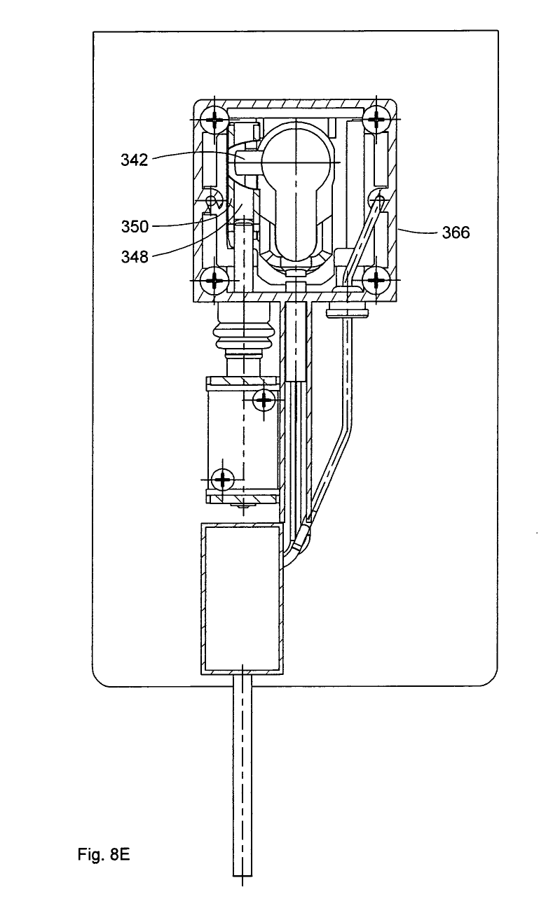

This sensor 72, 172 is located at the lower end of the mechanical lock 32, 232 in the embodiment forms according to FIGS. 1 to 6C and at the upper end in the embodiment forms according to FIGS. 7A to 8E.

For the rest, FIG. 7A shows a perspective view of the external parts of an embodiment form similar to that in FIG. 1; FIG. 7B is a rear view of the actuating mechanism installed in a door leaf similar to FIG. 1B, but with a different arrangement of the individual components and with a lateral holding plate 78 which proceeds from the cover 266 so as to form one piece with it and supports the lift magnet 246 and circuit 216; FIG. 7C shows the arrangement according to FIG. 7A in section parallel to the door leaf plane in which the lift magnet is not excited, while FIG. 7D shows the same view as in FIG. 7B, but with excited lift magnet. FIG. 7E shows the same view as in FIG. 7B, but with actuation of the slide by means of the cam 242 of a cylinder lock. The thin wall 10 is clamped between the cover 266 and trough 212.

FIG. 8A shows a perspective view of the external parts of an embodiment form similar to FIG. 7A, but with only one cylinder lock, while FIG. 8B shows a rear view of the actuation installed in a door leaf similar to FIG. 7B, but with a different arrangement of the holding plate 378, namely parallel to the door leaf plane.

FIG. 8C shows the arrangement according to FIG. 8A in section parallel to the door leaf plane, wherein the lift magnet 346 is not excited; FIG. 8D shows the same view as in FIG. 8B, but with excited lift magnet 346; and FIG. 8E shows the same view as in FIG. 8B, but with actuation by the cam 342 of a cylinder lock.

### COMMERCIAL APPLICABILITY

The invention is commercially applicable in switch cabinet construction.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### REFERENCE NUMBERS

10 thin wall, switch cabinet door
12, 212, 312 trough
14, 314 swivel lever actuating mechanism
16, 216, 316 safety device
18, 318 a longitudinal end of the trough
20, 120, 220, 320 shoulder
22, 322 another longitudinal end of the trough
24, 324 drive shaft
26, 326 hand lever
28 axis parallel to the fastening plane
30 axis perpendicular to the fastening plane
32, 232, 332 locking devices of the hand lever
34, 234, 334 complementary locking devices of the trough
36, 136, 236, 336 projection of the hand lever
38, 238 locking cylinder
40, 140, 240, 340 locking cylinder
42, 142 cam
44, 144, 244 pin
46, 146, 246, 346 electric drive
48, 148 slide
50, 150 push bearing
52, 152 end constructed as a latch
54, 154 piston-like end
56, 156 recess, opening
58, 158 projection
60, 160 bore hole
62, 162 holding surface
64, 164 opposite surface
66, 266, 366 cover
68 spring force
70, 170 supporting surface
72, 172, 272, 372 sensor
74, 174, 274, 374 cable
76, 176, 276, 376 cable
78, 378 holding plate
80, 280 cable for lift magnet

1. Swivel lever actuating mechanism with a safety device, comprising a trough (12, 312) which can be arranged on one side (outer side) of a thin wall (10) such as a switch cabinet door, wherein the trough (12, 312) has, at one of its longitudinal ends (18, 318), a shoulder (20, 320) whose cross section is substantially rectangular and which pierces the fastening plane formed by the thin wall (10) in the direction toward the other side (inner side) of the thin wall (10), and its other longitudinal end (22, 322) supports a drive shaft (24, 324) at which a hand lever (26, 326) with a projection (36, 336) is arranged so as to be swivelable out of the trough (12, 312) around an axis (28) parallel to the fastening plane and optionally so as to be rotatable in the trough (12, 312) around an axis (30) perpendicular to the fastening plane, wherein locking devices (32, 232 and 34, 234) proceed from the trough (12, 312) or hand lever projection (36, 236, 336) and cooperate with complementary locking devices (34, 234, 334, 32, 232, 332) of the hand lever projection (36, 236, 336) or trough (12, 312), characterized in that independently acting locking devices (144, 244, 344, 162) are provided for the free end of the hand lever (26, 326), in that a mechanical drive such as a locking cylinder (38, 40, 140) provided with a cam (42, 142, 242, 342) is arranged in the hand lever projection (36, 236, 336) in such a way that the cam (42, 142, 242, 342) moves the locking devices (32, 232, 332, 34, 234, 334) into the open or closed position when the locking cylinder (38, 40, 140, 240) is actuated, and in that at least one pin (44, 144, 244, 344) with an electric drive (46, 146, 246, 346) is arranged in or at the trough (12, 312) in such a way that the locking devices (32, 232, 332, 34, 234, 334) are moved into the closed or open position when the electric drive (46, 146, 246, 346) is actuated.

2. Actuating mechanism according to claim 1, characterized in that the locking device (32, 232, 34, 234) comprises a slide which is displaceable against spring force or gravitational force in a push bearing (50, 150, 250, 350) formed by the projection (36, 236, 336).

3. Actuating mechanism according to claim 1, characterized in that the locking device comprises a lever (26) which is swivelable against spring force or gravitational force in a swiveling bearing formed by the projection (36, 236).

4. Actuating mechanism according to claim 2 or 3, characterized in that the slide (48, 148) or the lever (26) has an end (52, 152) formed as a latch.

5. Actuating mechanism according to claim 4, characterized in that the slide (48, 148) has a piston-like end (54, 154) opposite the latch-like end (52, 152).

6. Actuating mechanism according to claim 5, characterized in that the slide (48, 148) has a projection or recess (56, 156, 58, 158) which is arranged between the latch-like end (52, 152) and the piston-like end (54, 154), the mechanical drive, such as cylinder cam (42, 142), engaging with the latter in order to move the slide (48, 148) against the spring force or gravitational force.

7. Actuating mechanism according to claim 6, characterized in that the push bearing (50, 150) has an open bore hole (60, 160) or cylinder for receiving the piston (54, 154) or the pin (44, 144).

8. Actuating mechanism according to one of claims 1 to 7, characterized in that the slide (48, 148) or the lever forms a holding surface (62, 162) next to the inclined run-in surface (52, 152) forming the latch, this holding surface (62, 162) forming an angle relative to the latter.

9. Actuating mechanism according to claim 8, characterized in that the holding surface (62, 162) of the slide (48, 148) or of the lever forms an angle to its movement direction such that the holding forces are overcome (spring lock function) when the actuating lever (26) is swung out.

10. Actuating mechanism according to claim 2, characterized in that the slide (48, 148) or the lever has an opposite surface (64, 164) relative to the holding surface (62, 162) so as to contain any movement play by the action of spring force or gravitational force.

11. Actuating mechanism according to one of claims 1 to 10, characterized in that the slide (48, 148, 248) or the lever is arranged next to one mechanical drive or between two mechanical drives such as two cylinders (38, 40, 140, 240) provided with cams (42, 142).

12. Actuating mechanism according to one of claims 1 to 11, characterized in that the trough forms a supporting surface for the pin (44, 144) near the push bearing.

13. Actuating mechanism according to one of claims 1 to 12, characterized in that the electric drive (246) is arranged below the mechanical drive (232) (FIG. 7C).

14. Actuating mechanism according to one of claims 1 to 12, characterized in that the electric drive (346) is arranged below the mechanical drive (340) and, additionally, a second electric drive is arranged between the mechanical drive (340) and the bearing (324) of the hand lever (326) (FIGS. 7B, 8B).

15. Actuating mechanism according to one of claims 1 to 14, characterized in that the mechanical drive is formed by two cylinder locks (38, 40) with shared slides (32) (FIGS. 3A, 7B).

16. Actuating mechanism according to one of claims 1 to 15, characterized in that the electric drive and the mechanical drive, and electronic components, if any, are jointly arranged on a base plate (78, 378) (FIG. 8B).
